(19) United States
(12) Patent Application Publication
(10) Pub. No.: US 2014/0298486 A1
(43) Pub. Date: Oct. 2, 2014

(54) GRANTING ACCESS TO DIGITAL CONTENT OBTAINED FROM A THIRD-PARTY SERVICE

(71) Applicant: POTTERMORE LIMITED, London (GB)

(72) Inventor: Peter Robertson, London (GB)

(73) Assignee: Pottermore Limited, London (GB)

(21) Appl. No.: 13/850,579

(22) Filed: Mar. 26, 2013

(51) Int. Cl. G06F 21/62

(52) U.S. Cl. CPC G06F 21/6218
USPC 726/28

(57) ABSTRACT

Described herein are third party digital content services for granting access to digital content. The third party digital content service is not associated with any particular end-user device or brand of end-user device and thus does not comprise means for transferring digital content directly to end-user devices configured to only receive digital content from an authorized vendor specific digital content service. The third party digital content service receives input from a user identifying an item of digital content which has been purchased or otherwise obtained from the third party digital content service. The third party digital content service then transmits a grant request to a vendor specific digital content service authorized to deliver content to a vendor specific end-user device or application. The grant request comprises authorization information for a vendor specific end-user account associated with the user.

### BACKGROUND

Electronic versions of books (e-books) are becoming increasingly popular and these books are read by users either on a dedicated electronic book reader (e-reader, one example of which is the NOOK®) or on an electronic book reader application which corresponds to one of these dedicated e-reader devices (one example of which is the NOOK® application) and these e-reader applications are typically available for both mobile phone and PC operating systems.

If a user wants to read an electronic book they access a vendor store (e.g. the NOOK store™) that sells or provides access to electronic books for the particular e-reader or e-reader application they own. The user then selects which electronic book they want to purchase or access (as some e-books are available free of charge) and the selected electronic book is pushed to a user device associated with the vendor store. For example, where the store is the NOOK store™, a selected electronic book can be pushed to a NOOK® e-reader and/or a device (e.g. a personal computer, or a tablet computer) running the NOOK® application. It will be appreciated that the NOOK® is referred to by way of example only and there are many other e-reader devices (and corresponding applications) available.

The embodiments described below are not limited to implementations which solve any or all of the disadvantages of known systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Described herein are third party digital content services for granting access to digital content. The third party digital content service is not associated with any particular end-user device or brand of end-user device and thus does not comprise means for transferring digital content directly to end-user devices configured to only receive digital content from an authorized vendor specific digital content service. The third party digital content service receives input from a user identifying an item of digital content which has been purchased or otherwise obtained from the third party digital content service. The third party digital content service then transmits a grant request to a vendor specific digital content service authorized to deliver content to a vendor specific end-user device or application. The grant request comprises authorization information for a vendor specific end-user account associated with the user.

A first aspect provides a third party digital content service to grant access to digital content obtained from the third party digital content service to an end-user device associated with a vendor specific digital content service, the third party digital content service comprising: a processor configured to receive an input from a user, the input identifying an item of digital content; and a communications interface in communication with the processor, the communications interface configured to transmit a grant request to a vendor specific digital content service to initiate granting of access rights to the identified digital content to a vendor specific end-user account associated with the user.

A second aspect provides a vendor specific digital content service to grant access to digital content obtained from a third party content service to an end-user device, the vendor specific digital content service comprising: a communications interface configured to receive a transfer request from the third party digital content service, the transfer request comprising authentication information for an end-user account and information identifying digital content; and a processor in communication with the communications interface, the processor configured to: determine whether the authentication information for the end-user account is valid; and if the authentication information for the user is valid, associate the identified digital content with the end-user account at the vendor specific digital content service so that the user can access the identified digital content from one or more end-user devices associated with the vendor specific digital content service.

A third aspect provides a method to grant access to digital content obtained from a third party digital content service to an end-user device associated with a vendor specific digital content service, the method comprising: receiving input at the third party digital content service from a user, the input identifying an item of digital content from a list of digital content obtained by a user from the third party digital content service; and transmitting a grant request to a vendor specific digital content service to initiate granting of access rights to the identified digital content to a vendor specific end-user account associated with the user.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a block diagram of an example system for granting access to digital content purchased (or otherwise obtained) from a third party digital content service;

FIG. 2 shows two example methods which may be implemented by the third party digital content service shown in FIG. 1;

FIG. 3 is a flowchart of an example method for authenticating a user;

FIG. 4 is a flowchart of an example method for granting a user of a vendor specific digital content service access to digital content obtained from a third party; and

FIG. 5 is a block diagram of an example computing-based device.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

As described above, in existing systems, an electronic book (e-book) is purchased from a particular vendor which is associated with a particular type of e-reader (or corresponding e-reader application) and there is no mechanism to directly transfer the electronic book purchased from one vendor store to a e-reader (or corresponding application) that is not associated with that vendor. This is because the e-reader vendors (and corresponding e-book stores) use proprietary formats/protocols for their e-books and/or for delivery of e-books to their e-readers or e-reader applications. For example, if a user has two different e-readers, or has an e-reader device of one type and also runs a different e-reader application on a separate device, they cannot transfer a purchased book between devices and instead they have to purchase the e-book twice (once for each e-reader type). In existing systems it may be possible to download an ePub file to different devices; however, in such examples the loading of the ePub file onto the device is not done directly by the vendor store but instead is done by side-loading (e.g. from a users PC to the e-reader).

Embodiments described herein relate to methods, systems and devices for providing access to digital content obtained from a third party to one or more end-user devices capable of receiving digital content from one or more authorized parties. For example, the methods and systems described herein may be used to allow users to purchase (e.g. using money or a voucher) electronic books from a third party and have them delivered to one or more electronic reader (e-reader) devices (e.g. a NOOK® or corresponding application). In an example, the books may be delivered to one or more different e-reader devices and/or e-reader applications. In other examples, the electronic books may not be purchased but instead may be provided free of charge (e.g. in the form of sample chapters).

The term ‘third party’ is used herein to refer to an entity which is not an e-reader service provider and instead, using the methods and systems described herein, the third party is able to grant users access to digital content (such as e-books) which can then be accessed via any e-reader device or corresponding e-reader application using this method. In some examples, the third party may be a publisher or rights owner for the digital content.

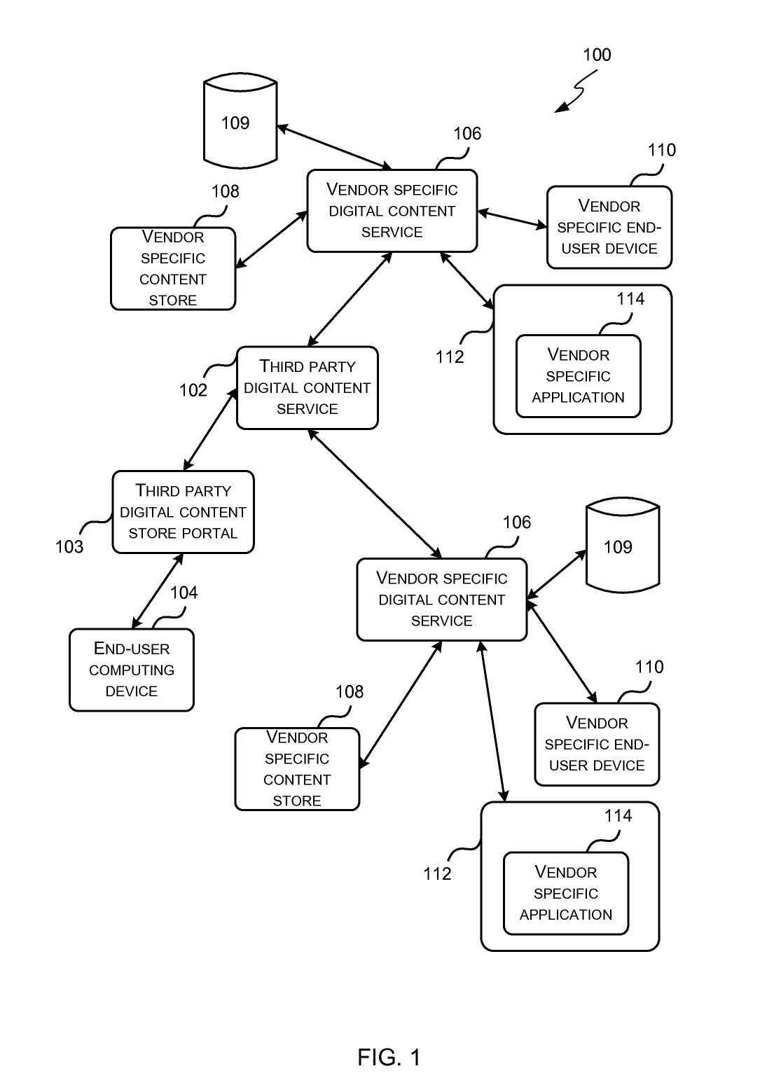

Reference is now made to FIG. 1 which illustrates a system 100 for providing access to digital content obtained from a third party to one or more end-user devices. The system comprises a third party digital content service 102 which has an associated store portal 103 that allows users to purchase or otherwise obtain digital content and an end-user computing device 104 for allowing a user to purchase or otherwise obtain digital content from the third party digital content store portal 103. The third party digital content service 102 allows users to view and manage the digital content they have purchased (or otherwise obtained) via the store portal 103. The system 100 further comprises a plurality of vendor specific digital content services 106, each having an associated vendor specific content store 108 and digital content repository 109. The vendor specific digital content services 106 are each arranged to provide digital content to a specific type of end-user devices, where these end-user devices may be a vendor specific device 110 or a computing device 112 running a vendor specific application 114 (e.g. the NOOK® application running on a smart-phone or tablet). The digital content itself is stored in a vendors associated digital content repository 109 and copies of the digital content are provided to end-user devices. Each vendor specific digital content service 106 has an associated digital content repository 109 in which the digital content is stored in the appropriate format for the vendor. The end-user devices 110, 112 are arranged to allow users to consume digital content (e.g. read an e-book, view a movie, etc) received from a vendor specific digital content service 106. The digital content which has been purchased or otherwise obtained may be pushed to the end-user devices 110, 112 or alternatively may be pulled by the end-user devices 110, 112 (e.g. in response to a user input). In some examples, a user may have an account (a vendor specific end-user account) with a vendor specific digital content service 106, but may not link any end-user devices to that account, in which case the user may access the digital content via a web portal associated with the vendor specific digital content service (not shown in FIG. 1). The elements 102-114 within the system 100 are interconnected by a data communications network which enables the communication paths indicated by the double ended arrows in FIG. 1. It will be appreciated that FIG. 1 shows only a subset of the possible communication paths between entities in the system 100.

The end-user computing device 104 is any computing-based device that is capable of communicating electronically with the third party digital content store portal 103 and the third party digital content service 102 to allow a user to purchase or otherwise obtain digital content and subsequently request that the digital content be made available to them via one or more end-user devices 110, 112. For example, the end-user computing device 104 may be a laptop computer, a desktop computer, a tablet computer, a smart-phone or any other suitable computing-based device. It will be appreciated that in some examples, the end-user computing device 104 may be running a vendor specific application 114 and as such the end-user computing device 104 and computing device 112 may be the same physical computing device.

The third party digital content service 102 runs on a computing-based device or set of computing-based devices and allows users to purchase or otherwise obtain the rights to digital content via the third party digital content store portal 103. The third party digital content service 102 also allows users to manage previously purchased digital content. The term “digital content” is used herein to mean any form of digital media such as electronic books, audio books, music, videos, games, 3D models, software and the like. The third party digital content service 102 comprises a library of digital content (“available content”) that can be purchased or obtained by users via the third party digital content store portal 103 using an end-user computing-based device 104. The third party digital content store portal 103 may, for example, be a website that allows users to access the library of digital content available from the third party and select digital content to purchase or otherwise obtain using a web browser running on the end-user computing device 104 or using an application associated with the third party running on the end-user computing device 104. Any known method for facilitating an electronic purchase of an item may be used to purchase or otherwise obtain the digital content and as described above, the purchase may not require any payment by the user (e.g. they may use a voucher).

Once the user has purchased or otherwise obtained the rights to digital content from the third party digital content service 102, the user can request that access rights to the purchased or obtained digital content are granted to one or more vendor specific end-user accounts. Once the access rights are granted to a vendor specific end-user account the digital content may then be transferred to end-user devices 110,112 associated with that vendor specific end-user account by the vendor specific digital content service 106. In some cases there may be a limit on the number of vendor specific end-user accounts to which access rights for a piece of digital content may be transferred (e.g. a limit on the number of grant requests which are allowed). In addition, or instead, the number of transfers to end-user devices permitted for any particular digital content may be limited. For example, users may only be able to transfer any purchased/obtained digital content to a maximum of four end-user devices or may only be able to grant access rights to four vendor specific end-user accounts. In other cases the number of transfers/grant requests (which result in access being granted) may be unlimited.

The third party digital content service 102 is operated by an entity that is not affiliated with any particular type or brand of end-user device (i.e. the entity operating the third party digital content service 102 is not affiliated with any of the vendors operating the vendor specific digital content services 106). Accordingly, the third party digital content service 102 does not comprise means to provide digital content directly to an end-user device that requires the digital content in a proprietary form or to an end-user device that only accepts content from an authorized/associated vendor specific digital content service 106. Thus to transfer particular digital content to an end-user device that requires the content in a proprietary form or only accepts content from an authorized/associated vendor specific digital content service, the third party digital content service 102 sends a grant request to a vendor specific digital content service 106 associated or authorized for use with the end-user device 110, 112 to notify the vendor specific digital content service 106 that the user is authorized to access the particular digital content. The vendor specific digital content service 106 then makes the specified digital content available to the vendor specific end-user account and any linked end-user devices 110, 112 and may transfer the digital content to those linked end-user devices automatically (e.g. in the form of a push transfer or in the form of a pull transfer when the end-user device next connects to the vendor specific digital content service 106) or in response to user input.

Each vendor specific digital content service 106 runs on a computing-based device or set of computing-based devices and is authorized to transfer digital content to a vendor specific end-user device 110 and/or to a vendor specific application 114 running on any suitable end-user device 112. For example, one vendor specific digital content service 106 may be the NOOK® service which provides the NOOK Store™ which is authorized to transfer e-books and other digital media to NOOK® e-readers and/or computing devices running the NOOK® application.

Each vendor specific digital content service 106 may allow users to purchase or otherwise obtain digital content for their vendor specific end-user device/application directly (e.g. via the vendor specific content store 108). However, as noted above, in these cases the purchased or obtained digital content can only be transferred directly to the particular type (or brand) of vendor specific devices/applications which are associated with the vendor specific digital content service 106. For example, e-books purchased from the NOOK Store™ can only be transferred to NOOK® e-readers and/or computing devices running the NOOK® application.

In contrast when digital content is purchased from the third party digital content service 102 (e.g. via the store portal 103) the digital content may be accessed via (e.g. transferred to) any type of end-user device where the associated vendor specific digital content service 106 accepts grant requests from the third party digital content service 102.

Before a vendor specific digital content service 106 will accept grant requests from a third party digital content service 102, an authentication process may be completed between the third party digital content service 102 and the vendor specific digital content service 106 and/or between the user and the third party digital content service 102 or the vendor specific digital content service 106.

An authentication process between the third party digital content service 102 and the vendor specific digital content service 106 creates a trust relationship between these two services. The process may involve the sharing of tokens, keys or shared secrets in order that subsequent communications between the two services can be authenticated (i.e. such that a receiving service can be sure that the communication originated from the transmitting service and not an entity pretending to be the transmitting service) and/or encrypted (e.g. using shared keys).

An authentication process for a user may be described as a linking operation as it links two different accounts belonging to the user: an end-user account with the third party digital content service 102 and a vendor specific end-user account. During the linking operation for a user the third party digital content service 102 makes an authentication request to the vendor specific digital content service 106. In some cases, the user may provide identifying information (e.g. log-in information for the vendor specific end-user account such as a username and password) directly to the vendor specific digital content service 106 (e.g. where the third party digital content store portal 103 provides a user interface, such as a frame or pop-up window, in which the vendor specific digital content service 106 presents its own authentication page in response to the authentication request) and this means that the user's sensitive log-in information does not need to ever be provided to the third party digital content service 102. In other cases, the user may provide identifying information to the third party digital content service 102 and these may be securely transferred to the vendor specific digital content service 106 as part of the authentication request.

During the authentication process the vendor specific digital content service 106 determines whether the received user information is valid and if so, provides the third party digital content service 102 with authentication information for the user's vendor specific end-user account and the end-user accounts with the two services 102, 106 are now described as being linked. The authentication information provided by the vendor specific digital content service 106 can then be used by the third party digital content service 102 to identify and authenticate the user's vendor specific end-user account when making a grant request. In some cases the authentication information is a software token. As is known to those of skill in the art a software token comprises information which can be later used by the vendor specific digital content service 106 to identify and authenticate the vendor specific end-user account. The software token may comprise a username, personal identification number and/or a secret which can only be confirmed by the vendor specific digital content service 106. It will be appreciated that a user's end-user account with the third party digital content service 102 may be linked to one or more vendor specific end-user accounts.

When the vendor specific digital content service 106 subsequently receives a grant request from the third party digital content service 102 comprising the authentication information for the user and information identifying the digital content selected by the user (via the third party digital content store portal 103), the vendor specific digital content service 106 verifies the request and if verified, associates the identified content with the user's vendor specific end-user account so that the user can access the identified digital content from corresponding vendor specific end-user devices 110 or applications 114 (i.e. those vendor specific devices/applications with the same vendor as the vendor specific digital content service). In some cases the vendor specific digital content service 106 automatically transfers the identified digital content to any vendor specific end-user devices/applications 110, 114 registered with the vendor specific digital content service 106 (and these devices/applications 110, 114 may be referred to as linked device/applications). In other cases, once the identified digital content is associated with an end-user account with the vendor specific digital content service 106 the user can manually initiate transfer of the identified digital content to their vendor specific end-user device/application. As described above, in some cases, a user may have no linked device/application and may instead access the digital content (which was the subject of a grant request) via a web portal provided by the vendor specific digital content service 106.

The end-user devices 110, 112 are computing-based devices that allow a user to receive and access (or otherwise consume) digital content. The end-user devices may be vendor specific (e.g. vendor specific device 110) or may be running a vendor specific application 114 and the end-user devices 110, 112 may, for example, be an e-reader, a personal computer, a tablet computer, a smart-phone, a digital music player (e.g. an MP3 player), a games console, a network connected TV, a 3D printer or any end-user device capable of receiving digital content. These device types may be logically divided into hardware devices (e.g. device 110) and software devices (e.g. application 114). Although the system 100 of FIG. 1 shows two end-user devices 110, 112 connected to each vendor specific digital content service 106, it will be evident to a person of skill in the art that the principles described herein may be equally applied to a system with more or fewer end-user devices.

When an end-user device is able to receive digital content from a particular vendor specific digital content service 106, the end-user device and the vendor specific digital content service are said to be “associated”.

In the example shown in FIG. 1 the non-vendor specific end-user devices 112 are each shown running a single vendor specific application 114 and connected to a single vendor specific digital content service 106. It will be appreciated, however, that such an end-user device 112 may run a plurality of vendor specific applications 114 (each vendor specific application 114 corresponding to a different vendor and hence different vendor specific digital content service 106) and so may be associated with (and connected to) a plurality of vendor specific digital content services 106.

Although the end-user computing device 104 and the end-user devices 110, 112 are shown as separate devices it will be evident to a person of skill in the art that there may be computing-based devices which are capable of performing the functions of both the personal computing device 104 and an end-user device 110, 112. For example, a laptop computer may run a web-browser that can be used to access the third party digital content store portal 103 and a vendor specific application 114 which allows it to receive and access digital content from a vendor specific digital content service 106. Similarly, a vendor specific device 110 may also be capable of running a web-browser that can be used to access the third party digital content store portal 103.

The data communications network which interconnects the elements 102-112 shown in FIG. 1 may be any network, or combination of networks, capable of enabling data communication between elements in the system 100. For example, the data communications network may be a public switched telephone network (PSTN), a mobile telephone network, a wireless data network, a wired data network, or any combination thereof. Different elements within the system may use different parts of the data communications network to communicate with other elements. For example, one end-user device 110 may communicate with an associated vendor specific digital content service 106 using a mobile communications part of the data communications network and another end-user device 112 may communicate with an associated vendor specific digital content service 106 using a wired data network part of the data communications network.

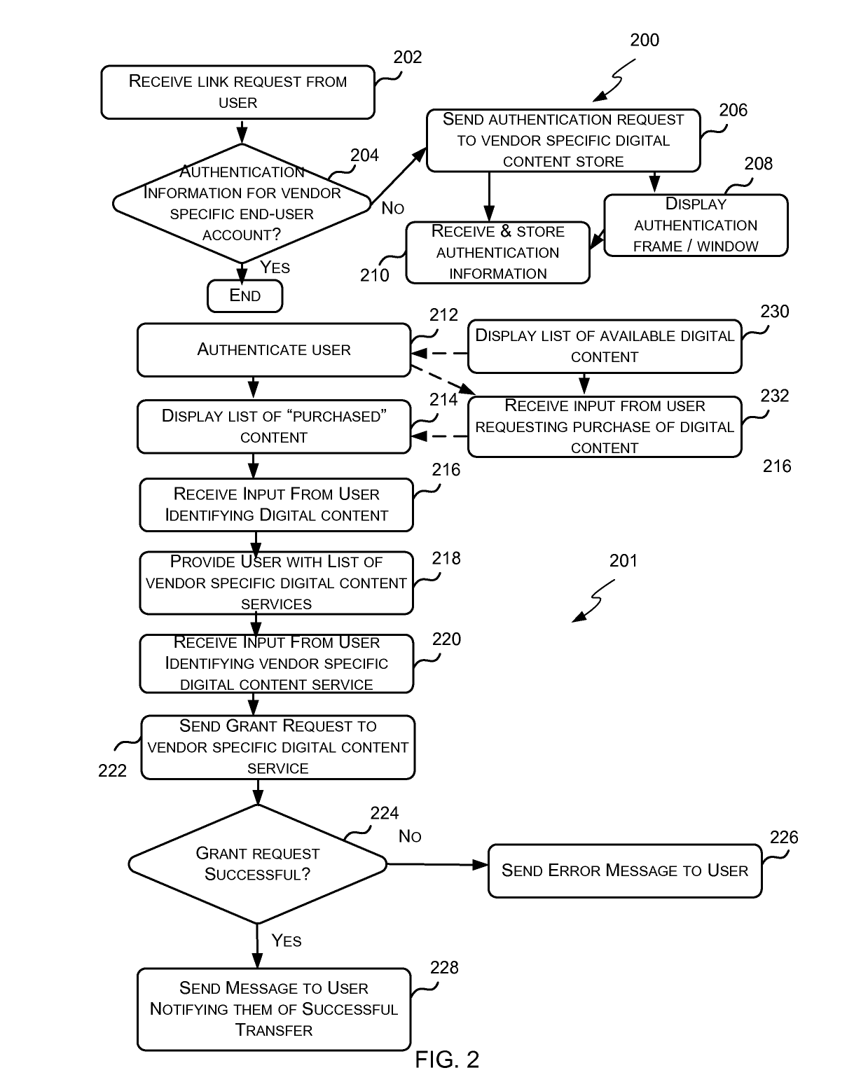

Reference is now made to FIG. 2 which illustrates two methods 200, 201, which may be executed by the third party digital content service 102. The first method 200 is a method of linking end-user accounts and the second method 201 is a method for granting access to digital content, where this access is granted to a linked vendor specific end-user account.

In the first method 200, at block 202, the third party digital content service 102 receives an input from a user which comprises a link request for a particular vendor specific digital content service 106. This user input may be received via the third party digital content store portal 103. At block 204, in response to the link request (received in block 202), the third party digital content service 102 determines whether the third party digital content service 102 has authentication information for the user for the identified vendor specific digital content service 106. In some cases, as described above, the authentication information may be a software token provided by the selected vendor specific digital content service 106. If the third party digital content service 102 has authentication information for the user for the selected vendor specific digital content service 106, the accounts are already linked for that particular user and the method 200 ends. However, if the third party digital content service 102 does not already have the authentication information, i.e. the end-user accounts are not already linked, (‘No’ in block 204), the method proceeds to block 206.

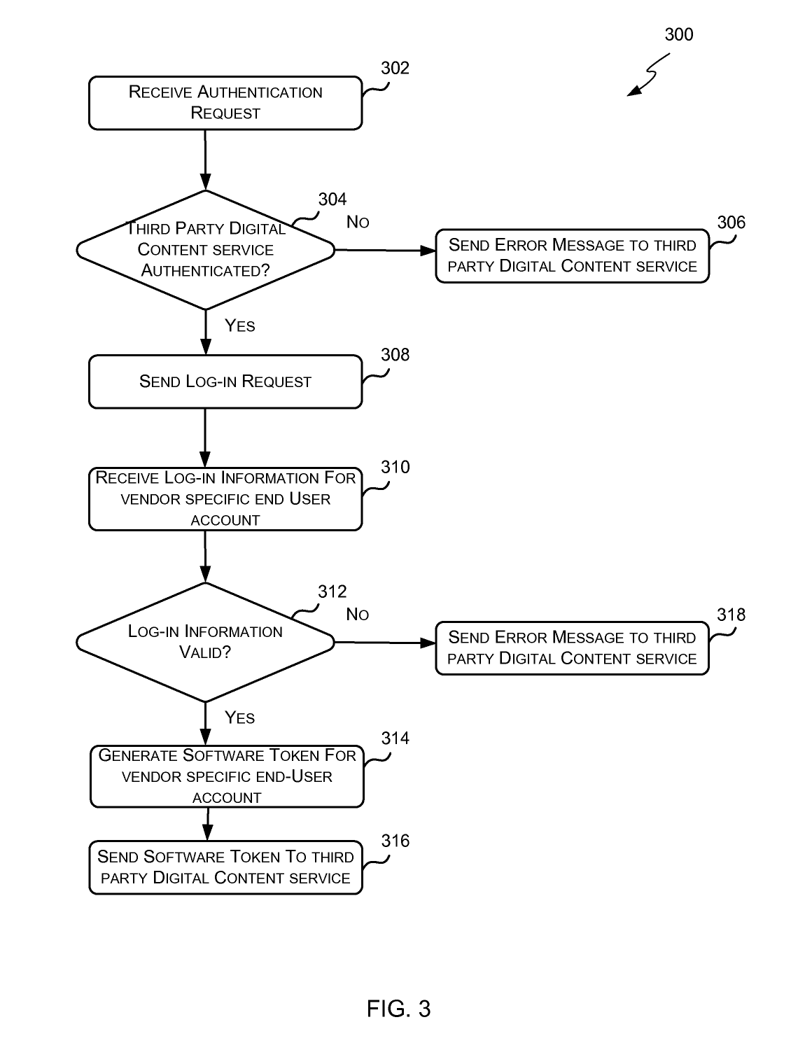

At block 206, the third party digital content service 102 sends an authentication request to the vendor specific digital content service 106. The authentication request may comprise information identifying the third party digital content service 102. In some cases the authentication request may also comprise information identifying the user (e.g. as provided by the user as part of the link request received in block 202). Once the vendor specific digital content service 106 receives the authentication request it may execute an authentication process to authenticate the user. In an example, in block 208, the third party digital content service 102 provides a frame within a web-page displayed to the user by the third party digital content service 102 or store portal 103 and this frame is used by the vendor specific digital content service 106 to present an authentication page. Alternatively, in block 208, the third party digital content service 102 may provide a separate pop-up window which is used by the vendor specific digital content service 106 to present an authentication page. An example authentication process which may be executed by the vendor specific digital content service 106 is described in reference to FIG. 3. The method 200 then proceeds to block 210.

At block 210, the third party digital content service 102 receives authentication information (e.g. a software token) for a vendor specific end-user account for the user from the vendor specific digital content service 106 and stores it for later user. At this point the end-user accounts for the user with the two services 102, 106 are linked. The authentication information is information that uniquely identifies the user (or their vendor specific end-user account) to the vendor specific digital content service 106. This can be used by the third party digital content service 102 to subsequently grant access to digital content via the linked vendor specific end-user account, as is shown in the second method 201 in FIG. 2.

Method 200 shows a method of linking accounts. It will be appreciated that the third party digital content service 102 may also implement a method of unlinking vendor specific end-user accounts, in which, in response to a user input (e.g. an unlink request), the stored authentication information for an identified vendor specific end-user account are deleted.

In the second method 201, at block 212, the user logs in to (or otherwise authenticates with) the third party digital content service 102. Logging in may, for example, comprise providing a username and/or password to the third party digital content service 102.

Once the log-in is complete the user, in block 214, may be given access to a list of any digital content that they have purchased and/or otherwise obtained from the third party digital content service 102. The user may be able to access the list of digital content by selecting a button or link, such as a “My Books”, from a main screen. Beside each of the listed digital content there may be button (e.g. a “download” or “select” button) or similar selection tool that allows the user to indicate that they wish to access the digital content via a particular vendor specific platform (e.g. end-user device or application).

At block 216, the third party digital content service 102 has receives an input identifying the digital content (selected from the list presented in block 214) the user wishes to access via a vendor specific end-user account (i.e. to one of their linked accounts). It will be appreciated that no actual transfer of digital content is occurring between the two digital content services 102, 106 but instead, the third party digital content service 102 grants access to the digital content by the particular vendor specific end-user account.

At block 218, the third party digital content service 102 provides the user with a list of vendor specific digital content services 106 that the selected digital content can be “transferred” to. The list of vendor specific digital content services provided to the user corresponds to any linked vendor specific end-user accounts for the user (e.g. where the linking of accounts may be performed as shown in method 200) and may also be based on the jurisdiction of the user and/or language of the digital content and the user. For example, some vendor specific digital content services may not support digital content in certain languages (e.g. Japanese). Similarly, some vendor specific digital content services may not support grant requests from users in certain jurisdictions (e.g. even where there is a linked end-user account). A user's jurisdiction may be manually provided by the user or determined from other information such as their billing address, IP address, GPS location, digital passport, credit card details, etc. Once the list of vendor specific digital content services has been provided to the user the method 201 proceeds to block 220.

In a variation of block 218, a list of vendor specific end-user accounts may be presented to a user instead of vendor specific end-user digital content services.

At block 220, the third party digital content service 102 receives input from the user which identifies the vendor specific digital content service 106 to which access rights are to be granted for the digital content selected in block 216. Upon receiving the user input indicating a vendor specific digital content service the method 201 proceeds to step 222.

At block 222, the third party digital content service 102 sends a grant request to the identified vendor specific digital content service 106. This initiates the granting of access to the digital content identified in step 202 by the user's vendor specific end-user account. In some cases the grant request comprises information identifying and/or authenticating the third party digital content service 102; information identifying and/or authenticating the user or vendor specific end-user account (e.g. the token provided during the authentication process of method 200); and information identifying the digital content to which access is to be granted.

In an example implementation of block 222, a grant request is sent to the vendor specific digital content service which contains an end-user token (as provided by the vendor specific digital content service during the authentication process) and a JSON payload message (which may be encrypted and base 64 encoded) which contains: a message ID, vendor specific SKU(s) which relate to the content, an end-user ID, and optionally a Personal Greeting and in some examples, additional IDs (e.g. an ID for the third party digital content store portal 103). The end-user token may be provided to the third party digital content service without encryption, but it may be provided over a secure channel using SSL.

The grant request may be communicated over a secure communication connection which may be encrypted or otherwise secured in any suitable way (e.g. through use of known endpoints). Once the grant request has been sent the method proceeds to block 224.

At block 224, the third party digital content service 102 receives a message from the vendor specific digital content service 106 indicating whether the grant request (i.e. the granting of access to the vendor specific end-user account) was successful or not. If the grant request was not successful the method 201 proceeds to block 226. If, however, the grant request was successful the method 201 proceeds to block 228.

In an example implementation of block 224, the response received from the vendor specific digital content service 106 contains a confirmation message or an error number.

At block 226, the third party digital content service 102 sends an error message to the user. In some cases the error message may provide the user information or details as to why the grant request failed. In other cases the error message may simply notify the user that the grant request has failed. Once the error message has been sent, the method 201 ends.

At step 228, the third party digital content service 102 sends a message to the user informing them that the grant request was successful. Once the message has been sent, the method 201 ends.

It will be appreciated that although method 201 shows a single error message (sent in block 226), error messages may also be generated at other points in the method (e.g. if any stage fails).

As described above in reference to FIG. 1, in some cases the third party digital content service 102 may impose a limit on the number of grant requests for any particular item of digital content. In some cases the third party digital content service 102 may only allow a maximum number of grant requests for an item of digital content (e.g. four grant requests). In these cases, prior to executing block 218, the third party digital content service may determine whether the user has reached their grant request limit. Determining whether the user has reached their grant request limit may comprise analyzing a counter for the particular digital content to determine if it has dropped below a predetermined threshold (e.g. it has dropped to zero). If the user has reached their grant request limit the third party digital content service may send an error message to the user and then terminate the method 201. If, however, the user has not reached their grant request limit the third party digital content service 102 may proceed to block 218 as normal. Once the method reaches block 228, the third party digital content service 102 may decrement the counter for the identified digital content that keeps track of the number of grant requests for the digital content.

In other cases the third party digital content service 102 may only allow digital content to be transferred to a certain number of end-user devices (e.g. four). In these cases the vendor specific digital content service 106 may provide the third party digital content service with the number of end-user devices to which the digital content has actually been transferred. Then when the counter for the identified digital content is decremented, the amount by which the counter is decremented may be based on the number of devices which received the digital content.

The third party digital content service 102 may be configured to allow a system administrator to adjust the counter and/or limit in certain situations (e.g. if the user is dissatisfied with a particular grant request or transfer).

In some cases the user may be able to select more than one digital content item at a time. In these cases, the third digital content service 102 may be configured to generate a single grant request that identifies all of the digital content items where access is to be granted. In other cases, the third party digital content service 102 may be configured to generate a separate grant request for each digital content item identified by the user.

The method 201 may be repeated in order to grant access to different vendor specific end-user accounts.

The method 201 in FIG. 2 as described above relates to granting access to digital content which has already been purchased or otherwise obtained by a user, such that the digital content appears in the list presented to the user in block 214. In order for digital content to appear in this list, the user may interact with the third party digital content store portal 103 to purchase, or otherwise obtain, items of digital content. As also shown in FIG. 2, in block 230, the third party digital content store portal 103 may display a list of available digital content to the user and subsequently, in block 232, receive a request from a user to obtain an item of digital content. A user may log-in to the third party digital content service 102 (in block 212) prior to being able to complete the purchase.

Reference is now made to FIG. 3 which illustrates a method 300, which may be executed by a vendor specific digital content service 106 for authenticating a user. At block 302, the vendor specific digital content service receives an authentication request from the third party digital content service 102. As described above, the authentication request may comprise information identifying the third party digital content service. Once the vendor specific digital content service has received the authentication request the method 300 proceeds to block 304.

At block 304, the information identifying the third party digital content service 102 is used by the vendor specific digital content service 106 to authenticate the third party digital content service to confirm that the request came from an authorized third party digital content service.

In an example implementation, in block 302 the third party digital content service sends through an HTTP post the following fields: End-userSessionId, Product UUID (universally unique identifier), TTL (time to live) and the callback URL. Upon successful authentication (in block 304), the vendor specific digital content service will respond with a token to identify the consumer.

If the vendor specific digital content service is unable to confirm that the request came from an authorized third party digital content service the method proceeds to block 306. However, if the vendor specific digital content service is able to confirm that the request came from an authorized third party digital content service then the method 300 proceeds to block 308.

At block 306, the vendor specific digital content service sends a message to the third party digital content service that the authentication has failed. Once the message indicating the authentication has failed is sent to third party digital content service the method 300 ends

At block 308, the vendor specific digital content service sends a log-in request to the third party digital content service 102 requesting log-in details for the user's vendor specific end-user account. In some cases the log-in request is displayed to the user (e.g. via end-user computing device 104) and this may be in the form of an authentication frame or pop-up window (e.g. as described above with reference to block 208 of FIG. 2). The user then provides the requested log-in details directly to the vendor specific digital content service. The log-in request may be in the form of a log-in screen which asks the user to provide log-in information, such as a username and password for the user's vendor specific end-user account. In other cases the third party digital content service obtains the log-in details from secure storage means and sends them to the vendor specific digital content service 106. For example, the third party digital content service may have previously obtained the user's log-in details (for the vendor specific end-user account) and stored them in secure storage means. Once the vendor specific digital content service has sent the log-in request to the third party digital content service 102, the method 300 proceeds to block 310.

At block 310, the vendor specific digital content service receives log-in information (e.g. username and password) for the user's vendor specific end-user account in response to the log-in request. As described above, the log-in information may be provided directly by the user or it may be provided by the third party digital content service 102. Once the vendor specific digital content service receives the log-in information, the method proceeds to block 312.

At block 312, the vendor specific digital content service determines whether the log-in information received in block 306 is valid. Determining whether the log-in information is valid may comprise comparing the log-in information received against log-in information stored by the vendor specific digital content service. For example, where the log-in information is a username and password the vendor specific digital content service may determine if it comprises an entry for the received username and if so, determine whether the received password matches the password associated with the received username. If the vendor specific digital content service determines that the log-in information is valid, the method 300 proceeds to block 314. If, however, the vendor specific digital content service determines that the log-in information is not valid, the method 300 proceeds to block 318.

At block 314, the vendor specific digital content service generates authentication information (e.g. a software or virtual token) for the user's vendor specific end-user account. As is known to those of skill in the art a software token comprises information which can be later used by the vendor specific digital content service to identify and authenticate the user. The software token may comprise a username, personal identification number and a secret which can only be confirmed by the vendor specific digital content service. Once the authentication information has been generated, the method 300 proceeds to block 316.

At block 316, the vendor specific digital content service provides the authentication information (e.g. software token) generated in block 314 to the third party digital content service 102. Once the third party digital content service receives the authentication information it can use the authentication information to submit grant requests to the vendor specific digital content service for the user (e.g. as described above with reference to FIG. 2). Once the vendor specific digital content service transmits the token to the third party digital content service 102 the method 300 ends.

At block 318, the vendor specific digital content service sends a message to the third party digital content service that the authentication has failed. Once the message indicating the authentication has failed is sent to third party digital content service the method 300 ends.

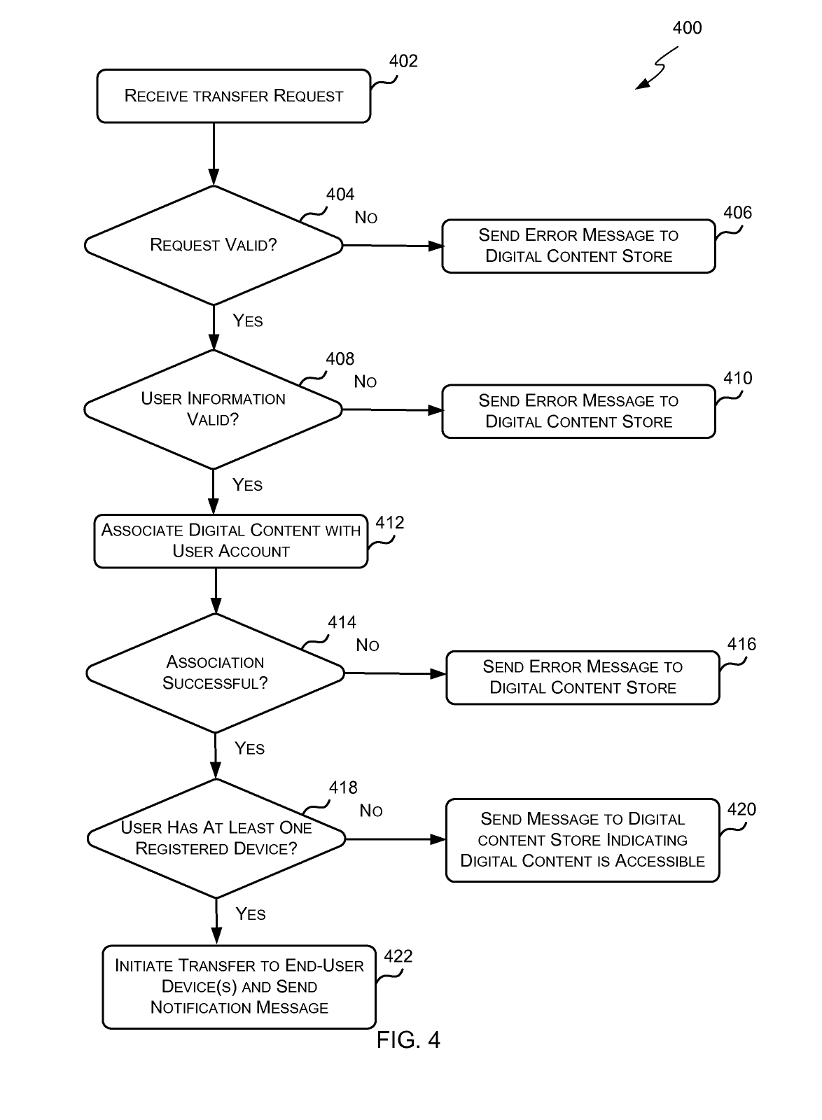

Reference is now made to FIG. 4 which illustrates a method 400, which may be executed by a vendor specific digital content service 106 to grant access rights to digital content to an vendor specific end-user account in response to receiving a grant request from a third party digital content service 102. At block 402, the vendor specific digital content service receives a grant request from the third party digital content service 102. The grant request may comprise information indicating the digital content for which are rights are to be granted and authentication information for the vendor specific end-user account. The authentication information may be the token generated by the vendor specific digital content service in block 314 of method 300. Once the vendor specific digital content service has received the grant request, the method 400 proceeds to block 404.

At block 404, the vendor specific digital content service determines whether the grant request received in block 402 is valid. In some cases determining whether the request is valid comprises determining if the request comprises all of the information required to process the request (e.g. information indicating the digital content for which rights are to be granted and authentication information for the vendor specific end-user account). In other cases determining if the request is valid comprises determining whether the vendor specific digital content service has the digital content specified in the request (e.g. stored in repository 109) and/or checking that the vendor specific end-user account is recognized and/or that the request is received over a secure link. If the vendor specific digital content service determines that the grant request is not valid, then the method 400 proceeds to block 406. If, however, the vendor specific digital content service determines that the grant request is valid, then the method proceeds to block 408.

At block 406, the vendor specific digital content service sends an error message to the third party digital content service notifying the third party digital content service that the request is not valid. The error message may comprise the following text or something similar: “Sorry there has been a technical problem. Please try again.” In some cases the third party digital content service may forward the message to the user (via the end-user computing device 104). Once the error message has been sent the method 400 ends.

At block 408, the vendor specific digital content service determines whether the authentication information for the vendor specific end-user account (e.g. software token) is valid. In some cases the authentication information may have an expiry date and determining whether the authentication is valid may determine if the authentication information has expired. In an example implementation (which uses OAuth), a consumer refresh token may be used to supersede previous tokens and cause the authentication information to expire.

If the vendor specific digital content service determines that the authentication information for the vendor specific end-user account is not valid, then the method 400 proceeds to block 410. If, however, the vendor specific digital content service determines that the authentication information for the vendor specific end-user account is valid, then the method 400 proceeds to block 412.

At block 410, the vendor specific digital content service sends an error message to the third party digital content service notifying the third party digital content service that the authentication information for the vendor specific end-user account is not valid. The error message may comprise the following text or something similar: “Your link with [vendor specific digital content service] account has expired” where [vendor specific digital content service] is a brief description of the vendor specific digital content service. In some cases the third party digital content service may forward the message to the user (via the end-user computing device 104). Once the error message has been sent the method 400 ends.

At block 412, the vendor specific digital content service attempts to associate the digital content identified in the grant request with the vendor specific end-user account identified in the grant request. Associating the digital content with the end-user account may comprise updating the end-user account at the vendor specific digital content service so that they can access the digital content in the same manner as if they had purchased or obtained the digital content from the vendor specific digital content service itself. For example, associating the digital content with the end-user account may comprise granting the user access to the stored digital content in the repository 109.

In some cases, prior to performing block 412, the vendor specific digital content service may determine whether the user is associated with a valid country. A valid country is a country that the vendor specific digital content service offers their services to. A user may be deemed to be associated with a specific country if their billing address is in the specific country. If the user is not associated with a valid country the vendor specific digital content service may send an error message to the third party digital content service and the method 400 may end. If, however, the user is associated with a valid country then the method 300 may proceed to block 412 as normal. In order to minimize the number of requests which fail at this stage, the third party digital content service 102 may hold a matrix of valid countries, languages and vendor specific digital content services 106 for each item of digital content.

At block 414, the vendor specific digital content service determines whether the association in block 412 was successful. If the association performed in block 412 was not successful then the method 400 proceeds to block 416. If the association performed in block 412 was successful then the method proceeds to block 418.

At block 416, the vendor specific digital content service sends an error message to the third party digital content service notifying the third party digital content service that the association failed. The error message may comprise the following text or something similar: “We were unable to process your request at this time. Please try again later.” In some cases the third party digital content service may forward the message to the user (via the end-user computing device 104). Once the error message has been sent to the third party digital content service the method 400 ends.

At block 418, the vendor specific digital content service determines whether the user has registered at least one device or at least one application with the vendor specific digital content service. If the user does not have any devices or any applications registered with the vendor specific digital content service then the method 400 proceeds to block 420. If, however, the vendor specific digital content service determines that the user has registered at least one device or at least one application with the vendor specific digital content service then the method 400 proceeds to block 422.

At block 420, the vendor specific digital content service sends a message to the third party digital content service notifying the third party digital content service that the digital content specified in the transfer request has been associated with the user's account with the vendor specific digital content service and that the user may visit the vendor specific digital content service directly to initiate the transfer to an end-user device. The message may comprise the following text or something similar: “[digital content] has been delivered to your [vendor specific digital content service] account. Please visit [vendor specific digital content service]'s website to learn more about how to transfer [digital content] to your device(s).” where [digital content] is a brief description of the digital content that has been associated with the user's account and [vendor specific digital content service] is a brief description of the vendor specific digital content service. In some cases the digital content service may forward the received message to the user (e.g. via the end-user computing device 104). In other cases the third party digital content service may process the received message to generate another message which is presented to the user. Once the message has been sent to the third party digital content service 102 the method 400 ends.

At block 422, the vendor specific digital content service automatically initiates a transfer of the specified digital content to the end-user devices and applications that have been registered with the user's vendor specific end-user account. For example, if the vendor specific digital NOOK Store™ and the user has registered two NOOK® e-readers and one NOOK® application (e.g. running on a tablet computer), the vendor specific digital content service may automatically transfer the specified digital content to the NOOK® e-readers and the devices running the NOOK® applications.

In addition to transferring the specified digital content to the end-user devices and applications that have been registered with the user's account the vendor specific digital content service may send a message to the third party digital content service notifying the third party digital content service that the digital content specified in the transfer request has been automatically transferred to the devices and applications registered with the user's account. The message may comprise the following text or something similar: “[digital content] has been sent to your [vendor specific digital content service] account and will be automatically delivered to your devices and applications. Please visit [vendor specific digital content service]'s website to view your account.” where [digital content] is a brief description of the digital content that was transferred and [vendor specific digital content service] is a brief description of the vendor specific digital content service.

Although in method 400 the vendor specific digital content service automatically initiates transfer of the digital content when the user has registered at least one end-user device or at least one application with the vendor specific digital content service. In other embodiments, the vendor specific digital content service may not automatically initiate transfer of the digital content even if the user has registered at least one end-user device or application with the vendor specific digital content service. In particular, the vendor specific digital content service may require the user to manually initiate the transfer from the vendor specific digital content service to specific end-user devices and/or applications. This allows the user to select which devices and/or applications they wish to receive the digital content. In these embodiments, blocks 418 and 422 may not be executed and the method may proceed directly from block 414 to 420.

There are a number of different ways in which the methods described above may be monetized. In an example, the third party digital content service 102 may provide an amount of money (e.g. which may be a proportion of the purchase price paid for the digital content) to each vendor specific digital content service 106 (e.g. up to a maximum number of vendor specific digital content services) to which grant requests are sent. As described above, the purchase of digital content (in block 232) is independent of which end-user device (or type of device) which is used by the user to consume the content and is also independent of which vendor specific digital content stores the grant requests are subsequently sent to.

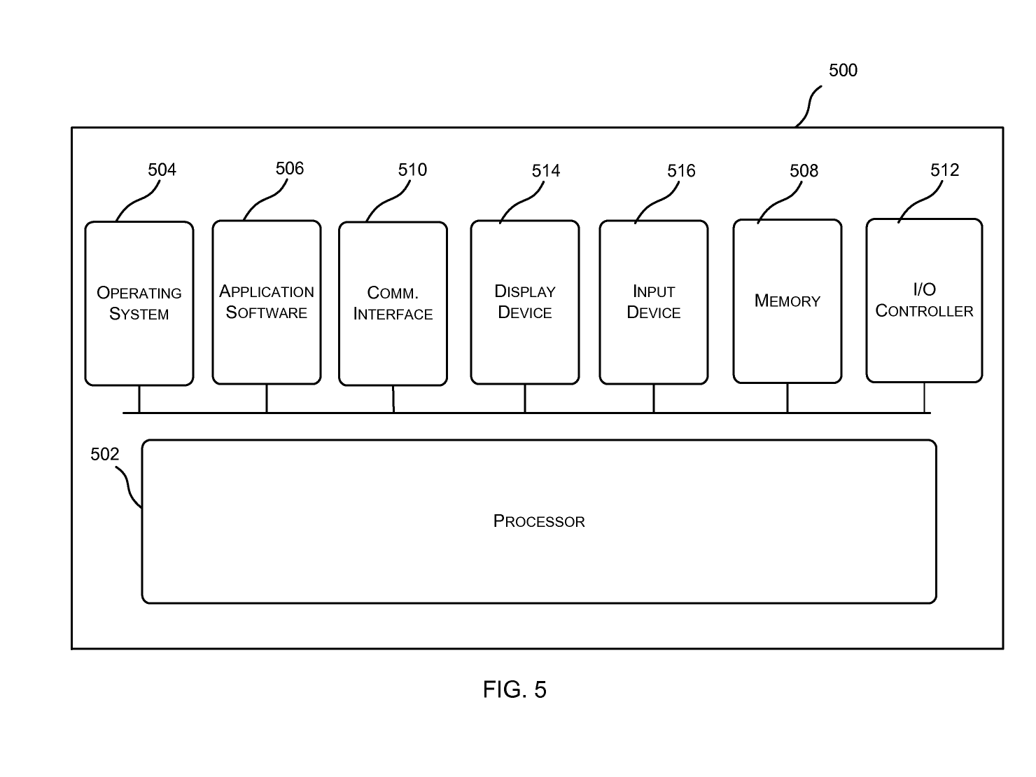

Reference is now made to FIG. 5 which illustrates an exemplary computing-based device 500 which may be implemented as any form of a computing and/or electronic device, and in which may be used to implement one or more of the third party digital content service 102, vendor specific digital content services 106, and end-user devices 104, 110, 112.

The computing-based device 500 comprises one or more processors 502 which may be microprocessors, controllers or any other suitable type of processors for processing computer executable instructions to control the operation of the device in order to run applications. In some examples, for example where a system on a chip architecture is used, the processors 502 may include one or more fixed function blocks (also referred to as accelerators) which implement a part of the method of operation of the computing-based device 500 or applications described herein in hardware (rather than software or firmware). Platform software comprising an operating system 504 or any other suitable platform software may be provided at the computing-based device 500 to enable application software 506 to be executed on the device.

The computer executable instructions may be provided using any computer-readable media that is accessible by the computing-based device. Computer-readable media may include, for example, computer storage media such as memory 508 and communications media. Computer storage media, such as memory 508, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 508) is shown within the computing-based device it will be appreciated that the storage may be distributed or located remotely and accessed via a network or other communication link (e.g. using communication interface 510).

The computing-based device 500 also comprises an input/output controller 512 arranged to output display information to a display device 514 which may be separate from or integral to the computing-based device 500. The display information may provide a graphical user interface. The input/output controller 512 is also arranged to receive and process input from one or more devices, such as a user input device 516 (e.g. a mouse or a keyboard). In an embodiment the display device 514 may also act as the user input device 516 if it is a touch sensitive display device. The computing-based device 500 may also be provided with other functionality as is known for such devices.

The term ‘processor’ and ‘computer’ are used herein to refer to any device with processing capability such that it can execute instructions. Those skilled in the art will realize that such processing capabilities are incorporated into many different devices and therefore the term ‘computer’ includes set top boxes, media players, digital radios, PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A third party digital content service to grant access to digital content obtained from the third party digital content service to an end-user device associated with a vendor specific digital content service, the third party digital content service comprising:
a processor configured to receive an input from a user, the input identifying an item of digital content; and
a communications interface in communication with the processor, the communications interface configured to transmit a grant request to a vendor specific digital content service to initiate granting of access rights to the identified digital content to a vendor specific end-user account associated with the user.

2. The third party digital content service according to claim 1, wherein the end-user device comprises a vendor specific end-user device or a vendor specific application running on an end-user device.

3. The third party digital content service according to claim 1, wherein
the processor is further configured to receive a link request from the user, the link request identifying a vendor specific digital content service; and
the communications interface is further configured to transmit an authorization request to the identified vendor specific digital content service and to receive, in response to the authorization request, authentication information for a vendor specific end-user account associated with the user.

4. The third party digital content service according to claim 3, wherein the communications interface is configured to receive a log-in request from the vendor specific digital content service in response to the authentication request, and to transmit user log-in details to the vendor specific digital content service in response to receiving the log-in request and prior to receiving the authentication information.

5. The third party digital content service according to claim 3, wherein the communications interface is configured to receive a log-in request from the vendor specific digital content service in response to the authentication request, and
the processor is further configured to present a user interface to the user, the user interface being controlled by the identified vendor specific digital content service.

6. The third party digital content service according to claim 3, wherein the authentication information is a software token.

7. The third party digital content service according to claim 3, wherein the grant request comprises the authentication information for the vendor specific end-user account.

8. The third party digital content service according to claim 1, wherein
the processor is further configured to:
provide the user with a list of one or more vendor specific digital content services based on the identified digital content; and
receive input from the user identifying one of the vendor specific digital content services from the list; and
the communications interface is further configured to:
transmit the grant request to the identified vendor specific digital content service.

9. The third party digital content service according to claim 8, wherein the list of one of more vendor specific digital content services is filtered based on one or more of a language of the user and a jurisdiction where the user is located.

10. A vendor specific digital content service to grant access to digital content obtained from a third party content service to an end-user device, the vendor specific digital content service comprising:
a communications interface configured to receive a transfer request from the third party digital content service, the transfer request comprising authentication information for an end-user account and information identifying digital content; and
a processor in communication with the communications interface, the processor configured to:
determine whether the authentication information for the end-user account is valid; and
if the authentication information for the user is valid, associate the identified digital content with the end-user account at the vendor specific digital content service so that the user can access the identified digital content from one or more end-user devices associated with the vendor specific digital content service.

11. The vendor specific digital content service according to claim 10, wherein
the processor is further configured to determine whether the user has registered at least one device with the vendor specific digital content service; and
the communications interface is further configured to automatically transfer the identified digital content to the at least one device if the processor has determined the user has registered at least one device with the vendor specific digital content service.

12. The vendor specific digital content service according to claim 10, wherein:
the processor is further configured to determine whether the received transfer request is valid; and
the communications interface is further configured to transmit an error message to the third party digital content service if the processor determines that the received transfer request is invalid.

13. The vendor specific digital content service according to claim 10, wherein:
the processor is further configured to determine whether the user is associated with a valid jurisdiction; and
the communications interface is further configured to transmit an error message to the third party digital content service if the processor determines that the user is not associated with a valid jurisdiction.

14. The vendor specific digital content service according to claim 10, wherein the communications interface is further configured to:
receive an authentication request from the third party digital content service;
transmit a log-in request to the third party digital content service in response to the authentication request; and
receive log-in information for the user in response to the log-in request.

15. The vendor specific digital content service according to claim 14, wherein
the processor is further configured to:
determine whether the received log-in information is valid; and
if the received log-in information is valid generate authentication information for the user; and
the communications interface is further configured to transmit the authentication information to the third party digital content service.

16. The vendor specific digital content service according to claim 15, wherein the authentication information is a software token.

17. A method to grant access to digital content obtained from a third party digital content service to an end-user device associated with a vendor specific digital content service, the method comprising:
receiving input at the third party digital content service from a user, the input identifying an item of digital content from a list of digital content obtained by a user from the third party digital content service; and
transmitting a grant request to a vendor specific digital content service to initiate granting of access rights to the identified digital content to a vendor specific end-user account associated with the user.

18. The method according to claim 17, further comprising:
receiving a link request from the user, the link request identifying a vendor specific digital content service;
transmitting an authorization request to the identified vendor specific digital content service;
receiving, in response to the authorization request, authentication information for a vendor specific end-user account associated with the user; and
storing the authentication information.

19. The method according to claim 17, further comprising:
providing the user with a list of one or more vendor specific digital content services based on the identified digital content; and
receiving an input from the user identifying one of the vendor specific digital content services from the list; and
wherein the grant request is transmitted to the identified vendor specific digital content service.

20. The method according to claim 19, further comprising:
filtering the list of one of more vendor specific digital content services based on one or more of a language of the user and a jurisdiction where the user is located, prior to providing it to the user.
